(19) United States
(12) Patent Application Publication
(10) Pub. No.: US 2002/0040734 A1
(43) Pub. Date: Apr. 11, 2002

(54) One- way control valve

(76) Inventors: Kazuo Yoneyama, Kawasaki-shi (JP); Ryouji Inagawa, Kawasaki-shi (JP)

Correspondence Address: ZITO TLP, 26005 RIDGE ROAD, SUITE 203, DAMASCUS, MD, 20872, US

(21) Appl. No.: 09/818,183

(22) Filed: Mar. 27, 2001

(30) Foreign Application Priority Data
Oct. 5, 2000 (JP) 2000-137104

(51) Int. Cl. F16K 15/04

(52) U.S. Cl. 137/539

(57) ABSTRACT

A one-way control valve, comprising a valve body guide hole for receiving a valve body movably in the hole; a fluid feed passage opened through a valve seat at one end of the valve guide hole; a fluid discharge passage opened through a spring retainer stepped portion at the other end of the valve body guide hole; and a coil spring compressed in the valve body guide hole and held at one end to the valve body and at the other end to the spring retainer stepped portion, is provided with a plurality of slit grooves opened at one ends to said spring retainer stepped portion within the hole for receiving the valve body and opened at the other ends to said fluid discharge passage are provided, an outside diameter of a circle on which such one ends of the plurality of slit grooves are opened being greater than an outside diameter of said coil spring, so that a desired flow rate of passing fluid can be secured even when fluid pressure to be fed is increased beyond a predetermined level.

### BACKGROUND OF THE INVENTION

The present invention relates to a one-way control valve for feeding pressurized fluid from one side to the other side and preventing the flow of fluid directed back from such other side. For instance, the one-way control valve is disposed in an oil feed passage in an internal combustion engine, a fuel feed passage of an acceleration pump device of a carburetor or the like.

FIG. 4 shows a conventional one-way control valve. Referring to FIG. 4, a valve body guide hole 1 extends in a longitudinal direction in a valve housing N and a valve body V that is in the form of a sphere is disposed movably in the interior of the hole 1. A fluid feed passage 3 is opened through a valve seat 2 at one end (on the right side in FIG. 4) of the valve body guide hole 1. Fluid such as oil, fuel or the like pressurized by an oil pump, a fuel pump or the like is fed from this fuel feed passage 3 into the valve body guide hole 1.

Also, a spring retainer stepped portion 4 is formed at the other end (on the left side in FIG. 4) of the valve body guide hole 1. A fuel discharge passage 5 is opened at the spring retainer stepped portion 4. A coil spring S compressed within the valve body guide hole 1 has one end retained by the valve body V and the other end retained by the spring retainer stepped portion 4. As a result, the valve body V is biased in contact with the valve seat 2 by the spring force of the coil spring S.

In accordance with the above-described one-way control valve, when the pressurized fluid is fed from the fluid feed passage 3 toward the interior of the valve body guide hole 1, the valve body V is moved to the left side away from the valve seat 2 by the pressurized fluid. The leftward movement of the valve body V is utilized to shift the valve body V to a position where the fluid pressure applied to the valve body V and the spring force of the coil spring S balances and to keep the valve seat 2 open. Thus, the fluid fed from the fluid feed passage 3 is discharged from the valve body guide hole 1 through the fluid discharge passage 5.

On the other hand, when the pressure of fluid directed from the fluid feed passage 3 to the interior of the valve body guide hole 1 is lowered below a predetermined level (near to atmospheric pressure), the valve body V is depressed to the right side by the spring force of the coil spring S. The valve body V is brought into contact with the valve seat 2 to thereby close the valve seat 2. As a result, the flow of fluid directed from the fluid feed passage 3 to the fluid discharge passage 5 is prevented.

Also, the flow of fluid from the fluid discharge passage 5 to the fluid feed passage 3 is utilized to close the valve seat 2 with the valve body V by the pressure of fluid depressing the valve body V to the right side and the spring force of the coil spring S. Thus, the flow of fluid from the fluid discharge passage 5 to the fluid feed passage 3 is prevented.

However, in such a conventional one-way control valve, there is a disadvantage that, when the pressure of fluid within the fluid feed passage 3 is increased above a predetermined level, it is impossible to feed a desired amount of fluid from the fluid discharge passage 5.

Referring now to FIG. 3, the flow rate of passing fluid to the fluid discharge passage 5 is considerably decreased at the fluid pressure above 0.35 (Kgf/cm²). This disadvantage is considered to occur due to the following fact. Namely, when the pressure of fluid within the fluid feed passage 3 is increased exceeding the predetermined level, the valve body V is largely shifted to the left side to cause the coil spring S to form a cylindrical wall under the fully compressed condition to thereby prevent the feed of fluid from the outer circumferential portion of the coil spring S to the inside fluid discharge passage 5.

In order to avoid such a disadvantage of the fully compressed condition of the coil spring S, there are some approaches to increase a spring constant of the spring, to increase a winding pitch of the spring, to decrease a number of winding or to elongate a free length of the spring. However, with such approaches, it takes long time to set the valve opening characteristics, degrading the development or design efficiency.

In view of the abovementioned disadvantage, the present invention is aimed to provide an one-way control valve such that a predetermined amount of fluid can be supplied even when the pressure of fluid is increased beyond a predetermined level, without changing the characteristic of the coil spring.

### SUMMARY OF THE INVENTION

According to a first aspect of the present invention, there is provided a one-way control valve comprising:

a valve body guide hole for receiving a valve body movably in the hole;

a fluid feed passage opened through a valve seat at one end of the valve guide hole;

a fluid discharge passage opened through a spring retainer stepped portion at the other end of said valve body guide hole; and

a coil spring compressed in said valve body guide hole and held at one end to the valve body and at the other end to the spring retainer stepped portion,

wherein a plurality of slit grooves opened at one ends to said spring retainer stepped portion within the hole for receiving the valve body and opened at the other ends to said fluid discharge passage are provided, an outside diameter of a circle on which such one ends of the plurality of slit grooves are opened being greater than an outside diameter of said coil spring.

Also, according to a second aspect of the invention, in addition to the first aspect, the one-way control valve is characterized in that a cross-section of each slit grooves perpendicular to a longitudinal axis of said fluid discharge passage is triangular.

According to the first aspect of the invention, under the condition that the pressure of fluid to be fed from the fluid supply passage is increased to exceed a predetermined level and the coil spring is fully compressed, when the coil spring forms a cylindrical wall, the fluid within the valve body receiving hole outside of the outer contour of the coil spring flows into the fluid discharge passage through the plurality of slit grooves whereby it is possible to feed the predetermined amount of fluid or more under such a condition.

Also, according to the second aspect of the invention, when the slit grooves are to be formed, the grooves may readily be formed by punching by using a punch corresponding to the shape of the grooves.

### BRIEF DESCRIPTION OF THE DRAWINGS

FIG. 1 is a longitudinal-sectional view showing a one-way control valve in accordance with an embodiment of the invention.

FIG. 2 is an enlarged cross-sectional view taken along the line A-A of FIG. 1.

FIG. 3 is a chart showing relation between fluid pressure in the fluid feed passage and flow rate of passing fluid to the fluid discharge passage.

FIG. 4 is a longitudinal-sectional view showing a conventional one-way control valve.

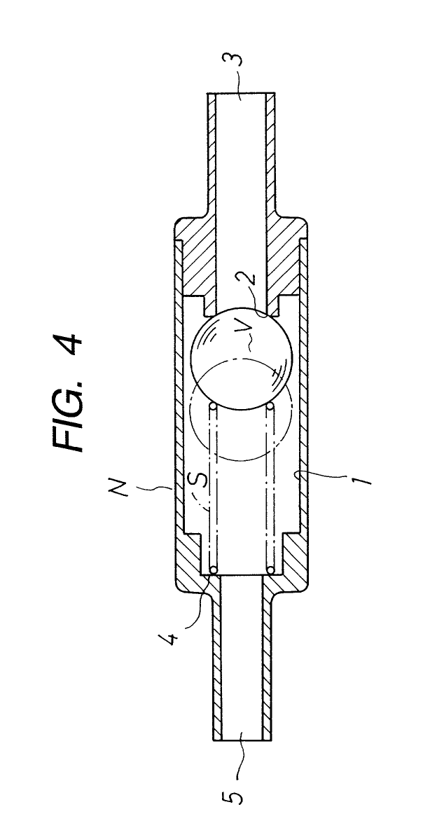

### DESCRIPTION OF THE PREFERRED EMBODIMENTS

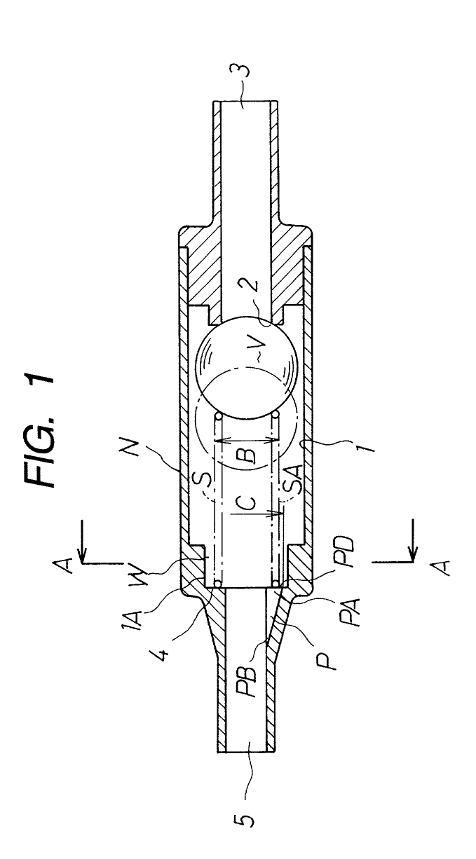

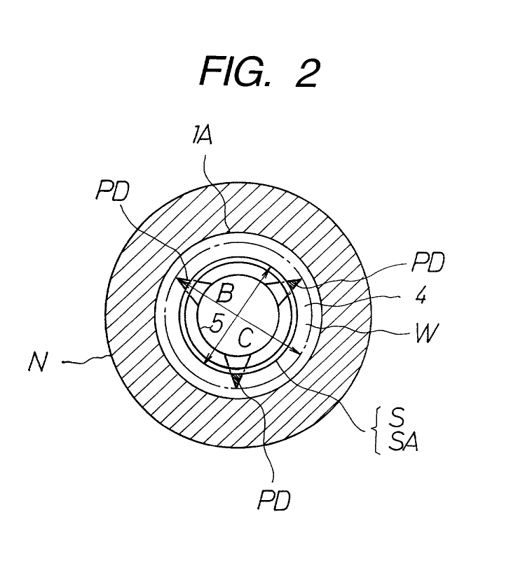

A one-way control valve in accordance with one embodiment of the present invention will now be described with reference to FIGS. 1 and 2. FIG. 1 is a longitudinal sectional view and FIG. 2 is a cross-sectional view taken along the line A-A of FIG. 1. Incidentally, the same reference numerals are used to indicate the same components or members and the duplication of explanation will be omitted.

A coil spring S disposed within a valve body guide hole 1 of a valve housing N has an outside diameter B with one end retained by the valve body V and the other end retained by a spring retainer stepped portion 4. Thus, an annular gap W extending along the longitudinal direction is formed between an outer contour SA of the coil spring S and an inner circumference 1A of the valve body guide hole 1.

A plurality of slit grooves P are formed to be directed to the spring retainer stepped portion 4. The grooves are formed as follows.

Namely, right ends PA of slit grooves P are opened at the spring retainer stepped portion 4 with an outside diameter C of a circle on which the right ends PA are opened being greater than an outside diameter B of the coil spring S.

In this example, the circle of the right ends PA have substantially the same diameter as outside diameter of the inner circumference 1A of the valve body guide hole.

The left ends PB of the slit grooves P extend leftward from the above-described right ends and to be opened continuously within the inside of the fluid discharge passage 5.

In other words, the slit grooves P are opened into the fluid discharge passage 5 continuously from the right ends PA to the left ends PB, whereas the right ends PA are opened to the spring retainer stepped portion 4 with the outside diameter C of the circle on which the right ends PA are opened being greater than the outside diameter B of the coil spring S.

With such an arrangement, the annular gap W and the slit grooves P are in communication with each other at the right ends PA of the slit grooves P that are opened at the spring retainer stepped portion 4.

Incidentally, in this embodiment, the slit grooves P are formed at three positions at an interval of 120 degrees, and the cross-sectional shape thereof is triangular in cross-section perpendicular to the longitudinal axis of the fluid discharge passage 5. However, the shape and the number of the grooves may be selected as desired and the valve body V is not limited to the ball valve. Also, the spring retainer stepped portion 4 is not limited to the flat surface but may be formed into a slanted surface.

The operation of the one-way control valve according to the present invention will now be described.

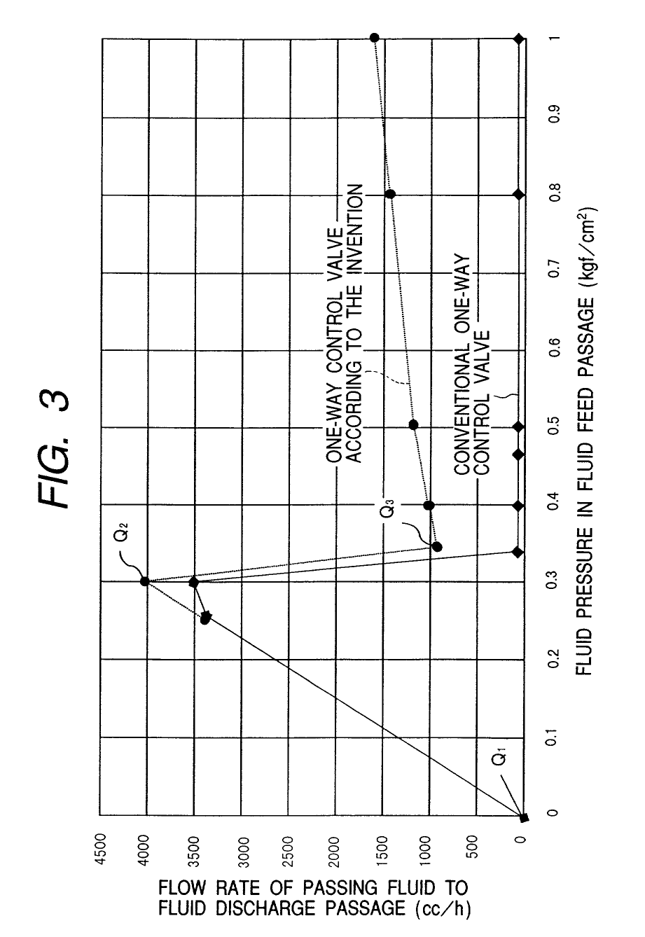

Under the condition that the pressurized fluid is not fed from the fluid feed passage 3, the valve body V is held in contact with the valve seat 2 by the spring force of the coil spring S. Thus, the fluid is prevented from flowing from the fluid feed passage 3 to the fluid discharge passage 5. This is shown at Q1 in FIG. 3.

Subsequently, the fluid pressure (Kgf/cm²) is gradually increased, the valve body V is subjected to the increased pressure and is shifted leftward in FIG. 1 up to the position where the fluid pressure balances with the spring force of the coil spring S. As a result, the amount of fluid flowing into the fluid discharge passage 5 (hereinafter referred to as flow rate of fluid passing) is increased in response to the increase of the fluid pressure. This is shown from Q1 to Q2 in FIG. 3. The flow rate of the fluid passing into the fluid discharge passage 5 is increased in the pressure increasing range up to 0.3 (Kgf/cm²).

Then, when the fluid pressure (Kgf/cm²) within the fluid feed passage 3 is further increased beyond 0.3 (Kgf/cm²), the flow rate of fluid passing is decreased gradually. At 0.35 (Kgf/cm²), the flow rate of fluid passing is most decreased.

Namely, when the pressure within the fluid feed passage 3 is further increased from 0.3 (Kgf/cm²), the coil spring S is brought into the remarkably compressed condition so that the gap between the adjacent winding portions is decreased and the flow rate of fluid pasing is decreased gradually. At 0.35 (Kgf/cm²), the coil spring S is brought into the fully compressed condition to form a cylindrical wall to most decrease the flow rate of fluid passing. However, in the one-way control valve according to the invention, when the fluid pressure within the above-described fluid feed passage 3 is increased up to 0.35 (Kgf/cm²), it is possible to obtain the desired flow rate of fluid passing. This is shown at Q3.

Namely, even if, at the fluid pressure of 0.35 (Kgf/cm²), the coil spring S is brought into the fully compressed condition, the cylindrical wall is formed by the coil spring S, and the annular gap W is formed between the outer contour of the coil spring S and the inner circumferential surface of the valve guide hole 1, the annular gap W is in communication with the fluid discharge passage 5 through the right ends PA of the slit grooves P opened to the spring retainer stepped portion 4, and the fluid within the annular gap W flows into the fluid discharge passage 5 through the slit grooves P from the openings of the right ends PA. Namely, the right ends PA of the slit grooves P are opened to the spring retainer stepped portion 4 with the outside diameter C of the circle on which the right ends PA are opened being greater than the outside diameter B of the coil spring S so that the fluid within the annular gap W may flow toward the fluid discharge passage 5 through the right end openings PD of the slit grooves P indicated by fine hatching in FIG. 2.

With such a structure, even if the fluid pressure within the fluid feed passage 3 is increased to exceed the predetermined pressure level so that the coil spring S is brought into the fully compressed condition, the desired amount of fluid may be fed toward the fluid discharge passage 5 through the slit grooves P to thereby completely solve the problem of the insufficient feed of the fluid.

Also, the above-described slit grooves may be formed by using a punch or the like. It is unnecessary to prepare a special member. Thus, the number of the parts is not increased and the number of the assembling steps is not increased. The manufacturing cost is not increased.

Incidentally, in particular, the relation between the flow rate of fluid passing and the fluid pressure at Q3 in FIG. 3 may be selected suitably in accordance with the shape and the number of the slit grooves P.

As described above, in the one-way control valve according to the invention, since the plurality of slit grooves opened at one ends to the spring retainer stepped portion within the valve body receiving hole with the outside diameter of the circle on which such one ends of the plurality of slit grooves are opened being greater than the outside diameter of the coil spring and opened at the other ends to the fluid discharge passage are provided, it is possible to feed fluid to the fluid discharge passage through the slit grooves even if the fluid pressure within the fluid feed passage is increased so that the coil spring is brought into the fully compressed condition and the necessary flow rate of fluid passing can be secured.

Also, according to the invention, since it is sufficient to simply apply the slit grooves to the conventional one-way control valve, neither the number of the parts nor the number of the assembling steps is increased. The manufacturing const is not increased.

Also, it is not necessary to change the conventional coil spring. No change occurs in the valve opening characteristics of the valve body.

What is claimed is:

1. A one-way control valve comprising:
a valve body guide hole for receiving a valve body movably in the hole;
a fluid feed passage opened through a valve seat at one end of the valve guide hole;
a fluid discharge passage opened through a spring retainer stepped portion at the other end of said valve body guide hole; and
a coil spring compressed in said valve body guide hole and held at one end to the valve body and at the other end to the spring retainer stepped portion,
where a plurality of slit grooves opened at one ends to said spring retainer stepped portion within the hole for receiving the valve body and opened at the other ends to said fluid discharge passage are provided, an outside diameter of a circle on which such one ends of the plurality of slit grooves are opened being greater than an outside diameter of said coil spring.

2. The one-way control valve according to claim 1, wherein a cross-section of each slit grooves perpendicular to a longitudinal axis of said fluid discharge passage is triangular.
